(19) United States
(12) Patent Application Publication
(10) Pub. No.: US 2005/0243751 A1
(43) Pub. Date: Nov. 3, 2005

(54) Time slot reservation method for multicast data in wireless network

(75) Inventors: Won-yong Yoon, Yongin-si (KR); Yong-suk Kim, Deajeon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/116,347

(22) Filed: Apr. 28, 2005

Related U.S. Application Data
(60) Provisional application No. 60/565,876, filed on Apr. 28, 2004.

(30) Foreign Application Priority Data
Nov. 3, 2004 (KR) 2004-88652

(51) Int. Cl. H04J 3/24

(52) U.S. Cl. 370/312

(57) ABSTRACT

A method for recognizing a receiving node by a transmitting node which transmits multicast data, and transmitting the multicast data to the receiving node in a wireless network including nodes that transmit and receive multicast data in at least one time slot. The transmitting node transmits a multicast solicit message indicating generation of the multicast data, and recognizes the receiving node by receiving from the receiving node a multicast join message containing information relating to the receiving node. The transmitting node selects at least one free time slot to reserve a time slot in which the generated multicast data is transmitted. The transmitting node transmits a multicast reservation request message containing information relating to the selected free time slot to the receiving node. The receiving node transmits a reservation response message to the transmitting node when the free time slot does not collide with reserved time slots of other nodes.

### CROSS-REFERENCE TO RELATED APPLICATIONS

This application claims the benefit under 35 U.S.C. §119 (e) of U.S. Provisional Application No. 60/565,876 filed on Apr. 28, 2004 in the United States Patent and Trademark Office, and priority from Korean Patent Application No. 2004-88652 filed on Nov. 3, 2004 in the Korean Intellectual Property Office, the entire disclosures of which are incorporated herein by reference.

### BACKGROUND OF THE INVENTION

1. Field of the Invention

The present invention generally relates to a wireless network including a plurality of nodes. More particularly, the present invention relates to a time slot reservation method for transmitting and receiving multicast data by a node in a wireless network.

2. Description of the Related Art

A node in a wireless network transmits unicast data or multicast data. The unicast data is destined for a specific node, and the multicast data is destined for at least two nodes.

FIG. 1 illustrates a wireless network including a plurality of nodes A through E. The following explains a method for unicasting data being generated. When the node A has data ready to transmit to the node B, the node A appends an address of the node B (receiving node address) to the data and transmits the data to the nodes B through E. Upon receiving the data, the nodes B through E extract the receiving node address from the data. As the extracted address is the same as its address, the node B forwards the received data to its upper layer. In comparison, as the nodes C through E extract the receiving node address different from their addresses, the nodes C through E drop the received data. It is noted that the nodes C through E can retransmit the received data rather than dropping the data.

If the node A has data ready to transmit to the nodes B and C, the node A sends data including a multicast address to the nodes B through E. The subsequent process is the same as the data unicast described above. The nodes B and C know the multicast address. The nodes B and C recognize that the data is destined for themselves by extracting a receiving node address (multicast address) from the received data, and forward the received data to their upper layer.

According to the conventional method, when a transmitting node wants to transmit multicast data, the transmitting node notifies nodes located within a specific range of the multicast data transmission. In detail, the transmitting node transmits a message including its address and a multicast address to the nodes located within the specific range. A node among the nodes within the specific range, which wants to receive the multicast data, waits to receive multicast data from the transmitting node without responding to the transmitting node. That is, the transmitting node does not obtain information relating to the receiving node which receives the multicast data.

Hence, the transmitting node experiences difficulty in searching a time (a time slot) to transmit the multicast data. Specifically, since the transmitting node does not know information relating to the receiving node which is to receive the multicast data, the transmitting node cannot reserve a time slot (free time slot) which does not collide with other time slots being utilized or reserved by neighbor nodes. Furthermore, it may happen that the transmitting node cannot transmit the entire data using only the reserved time slots due to failure in the radio channel.

FIG. 2 depicts collisions of multicast data received at nodes according to the conventional method. The node C transmits multicast data to nodes located within a specific range, and the node E also transmits multicast data to nodes located within a specific range. The multicast data from the node C arrives at the nodes A, B, and D. The multicast data from the node E arrives at the nodes D, F, and G. It is to be appreciated that the transmission distances of the multicast data from the node C and the node E are different from each other. It is assumed that the node D is to receive the multicast data from the node C.

Upon transmitting the multicast data in a reserved time slot, the node C waits to receive multicast data in the reserved time slot. However, it occurs that the node E transmits data in the same reserved time slot. As the node D receives two data in the same time slot, the two data collide with each other. As a result, there is a need for a method enabling the transmitting node to reserve a time slot so that the receiving node can receive multicast data without errors or failure.

### SUMMARY OF THE INVENTION

The present invention has been provided to address the above-mentioned and other problems and disadvantageous occurring in the conventional arrangement, and an aspect of the present invention provides a method for reserving a time slot by a transmitting node so that a receiving node can receive multicast data without errors or failure.

Another aspect of the present invention provides a method for enhancing spatial efficiency in a manner that a transmitting node obtains time slot usage information of a receiving node and neighbor nodes.

To achieve the above aspects of the present invention, a method for recognizing a receiving node by a transmitting node which transmits multicast data, and transmitting the multicast data to the recognized receiving node in a wireless network including a plurality of nodes that transmit and receive multicast data in at least one time slot, comprises the steps of transmitting a multicast solicit message indicating generation of the multicast data when the multicast data is generated; and recognizing the receiving node by receiving from the receiving node a multicast join message containing information relating to the receiving node.

The transmitting node selects at least one free time slot to reserve a time slot in which the generated multicast data is transmitted. The transmitting node transmits a multicast reservation request message containing information relating to the selected free time slot to the receiving node. The receiving node transmits a reservation response message to the transmitting node when the free time slot contained in the reservation request message does not collide with reserved time slots of other nodes.

The transmitting node selects a reserved time slot as the free time slot when a neighbor's neighbor node being a multicast data receiving node does not use the reserved time slot. Alternatively, the transmitting node selects a reserved time slot as the free time slot when a neighbor node being a multicast data transmitting node does not use the reserved time slot.

### BRIEF DESCRIPTION OF THE DRAWING FIGURES

These other aspects and/or advantages of the invention will become apparent and more readily appreciated from the following description of exemplary embodiments, taken in conjunction with the accompanying drawing figures of which:

FIG. 1 illustrates a wireless network including a plurality of nodes;

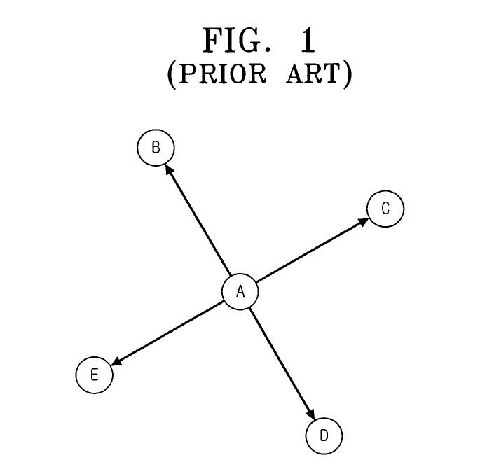

FIG. 2 illustrates collision of data transmitted and received in a wireless network including a plurality of nodes;

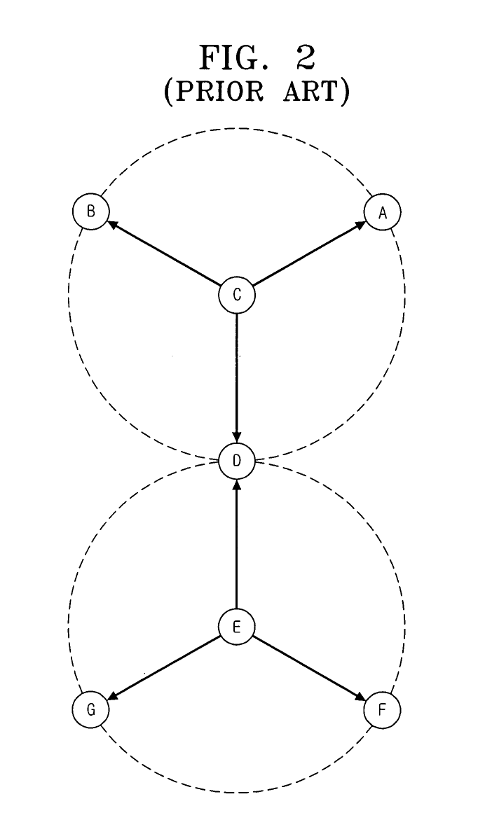

FIG. 3 illustrates operations for reserving a free time slot which does not collide with data transmitted and received in a wireless network including a plurality of nodes according to an embodiment of the present invention;

FIG. 4 illustrates that a reserved free time slot of a node is used according to an embodiment of the present invention; and

FIG. 5 illustrates that a reserved free time slot of a node is used according to an embodiment of the present invention.

### DETAILED DESCRIPTION OF THE EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

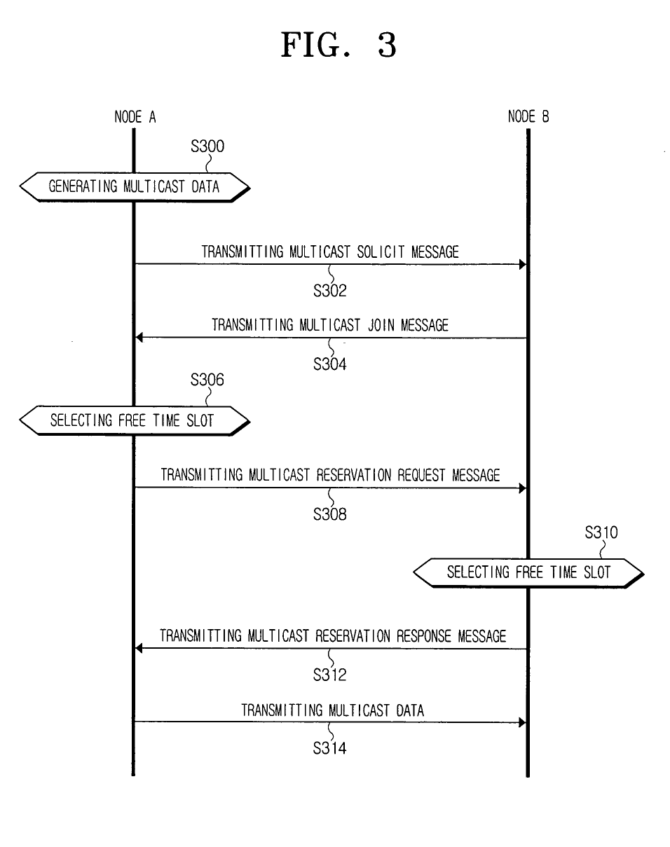

FIG. 3 illustrates that a transmitting node and a receiving node reserve a free time slot to transmit and receive multicast data in a wireless network according to an embodiment of the present invention. The following details operations of a node A (transmitting node) and a node B (receiving node) in the wireless network in reference to FIG. 3 according to an embodiment of the present invention. Although FIG. 3 depicts only one receiving node to facilitate understanding of the present invention, it should be understood that the wireless network includes at least one receiving node.

The node A recognizes the generation of multicast data to transmit to nodes located within a specific range (S300). The node A can be provided with the multicast data from a neighbor node.

The node A transmits a multicast solicit message to nodes located within the specific range (S302). The multicast solicit message indicates that a node which is to receive the multicast data from the node A notifies the node A of its information. Generally, the multicast solicit message can contain an address of the node A, and a multicast address for the multicast data transmission and reception.

Upon receiving the multicast solicit message, the node determines whether to receive the multicast data from the node A. In FIG. 3, the node B wants to receive the multicast data from the node A. Hence, the node B sends a multicast join message to the node A (S304). The multicast join message contains an address of the node B. Upon receiving the multicast address, the node A can learn that the nodes want to receive the multicast data. The node A sends an acknowledge (ACK) message to the node that transmits the multicast join message. That is, the node A can reconfirm that the node transmits the multicast join message by transceiving the ACK message.

Next, the node A selects a time slot for the multicast data transmission. Hereinafter, a time slot to reserve for the multicast data transmission is selected from free time slots. Typically, a frame consists of 256 time slots. The 256 time slots are properly allocated to nodes in the wireless network so as to prevent data collisions during the data transmission and reception. To be specific, neighbor nodes transmit data in different time slots, respectively, to prevent the data collisions.

The node A selects a free time slot using a beacon received from the receiving node (S306). The beacon is utilized generally for synchronization between nodes, but contains required information to select the free time slot according to an embodiment of the present invention. Each node appends information relating to its reserved or using time slot and information relating to time slots reserved or used by neighbor nodes, to the beacon. According to an embodiment of the present invention, nodes in the wireless network transceive information relating to their using or reserved time slots and whether they use their time slots. Accordingly, the node can know time slots being used and reserved time slots of the neighbor nodes, and whether the neighbor nodes use the time slots. Table 1 shows operations indicated by time slots according to a bit value contained in the beacon.

TABLE 1

| Tx/Rx bit | Operation |
|---|---|
| 00 | Receive unicast data and transmit ACK message |
| | (receiving node) |
| 01 | Transmit unicast data and receive ACK message |
| | (transmitting node) |
| 10 | Receive multicast data (receiving node) |
| 11 | Transmit multicast data (transmitting node) |

The Tx/Rx bit consists of two bits and indicates an operation of each node conducted in the relevant time slot. A node receives unicast data and transmits an ACK message in response to the unicast data in the time slot with the Tx/Rx bit ‘00’. The node A selects a free time slot by use of the beacon, which does not collide with time slots being used or reserved by the receiving nodes. The selection of the free time slot using the received beacons will be explained below.

The node A sends to the node B a multicast reservation request message containing information relating to the selected free time slots in operation S306 (S308). Upon receiving the multicast reservation request message from the node A, the node B selects a free time slot to receive multicast data (S310). The free time slot selection in operation S310 is the same as in operation S306.

The node B determines whether the free time slot contained in the received multicast reservation request message is identical with the selected time slot in operation S310. If so, the node B transmits to the node A a multicast reservation response message indicating that the node B accepts the free time slot received in operation S308 (S312).

If not, the node B transmits to the node A a multicast reservation cancel message indicating that the received free time slot is not accepted in operation S308 (S312). In this case, the node A can reselect a free time slot in which the multicast data is transferred, by means of the received beacons. Alternatively, the node B extracts the same free time slots from the received free time slots and the free time slots selected in operation S310. The node B can transmit a multicast reservation response message containing information relating to the extracted free time slots (S312). The node A can transmit the multicast data using only the free time slot appended to the multicast reservation response message.

Upon receiving the multicast reservation response message from the nodes which request to receive the multicast data, the node A transmits the multicast data to the receiving nodes located within a specific range (S314). The multicast data contains a multicast address. According to an embodiment of the present invention, the transmitting node transmits multicast data, but does not receive an ACK message in reply to the multicast data. In addition, the receiving node receives multicast data, but does not transmit an ACK message in reply to the multicast data.

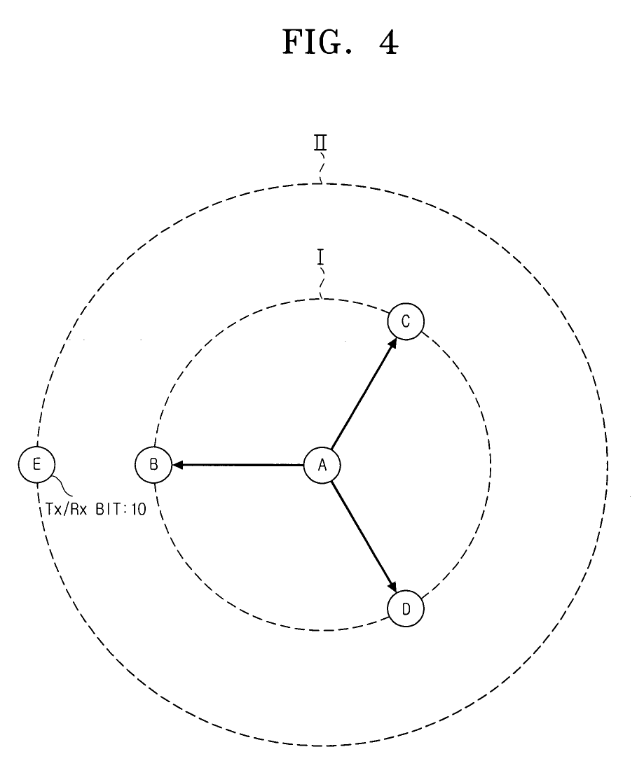

FIG. 4 illustrates that a reserved time slot of a neighbor node is utilized according to an embodiment of the present invention, which is described in detail.

A node E reserves a certain time slot to receive multicast data. To facilitate understanding, the certain time slot is a time slot 0. As shown in FIG. 4, the node E has a Tx/Rx bit ‘10’ in the time slot 0. However, it may happen that the node E cannot receive multicast data, excluding multicast data from a node A, in its reserved time slot. A node B provides the node A with information indicating that the node E does not use the reserved time slot, by use of a beacon.

The node A recognizes that the node A can use the reserved time slot 0, instead of the node E, based on the information provided from the node B. The node A can use the time slot 0 to transmit multicast data if the time slot 0 with the Tx/Rx bit ‘10’ of a neighbor's neighbor node is not used. As a result, the node A can extend the number of time slots in which the multicast data is transferred. As compared with the conventional method to transmit multicast data in consideration of an area I alone, the multicast data is transmitted in consideration of an extended area II as shown in FIG. 4.

The node B can receive the multicast data from the node A in the reserved time slot 0 of the node E without collision. Specifically, if a neighbor node does not use the time slot 0 with the Tx/Rx bit ‘10’, the node B receiving the multicast data can utilize the time slot instead.

FIG. 4 depicts that the node B has only one neighbor node. If the node B has at least two neighbor nodes, the node B needs to determine whether to use reserved time slots of the neighbor nodes in consideration of the at least two neighbor nodes.

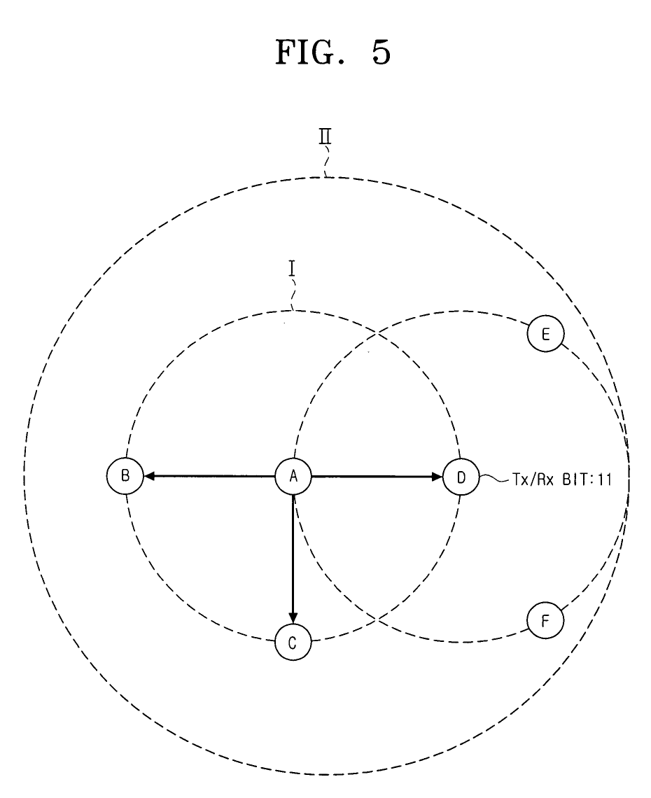

FIG. 5 depicts that a reserved free time slot of a neighbor node is used according to an embodiment of the present invention.

It is assumed that a node D receives multicast data from a node A and transmits multicast data to its neighbor nodes. Also, it is assumed that the node D reserves a time slot 1 to transmit the multicast data. The node D has a Tx/Rx bit ‘11’ in the time slot 1. As mentioned above, it may occur that the node D does not use all of the reserved time slots but defers using some of the time slots. Given that the deferred time slot is a time slot 1, information relating to the time slot 1 is provided to the node A by means of a beacon.

The node A recognizes that the reserved time slot 1 of the node D can be used based on the provided information. If the neighbor node does not use the time slot 1 with the Tx/Rx ‘11’, the node A to transmit multicast data can use the time slot 0 instead. Therefore, the node A can extend the number of the time slots available to transmit the multicast data. To be specific, compared with the conventional method that transmits multicast data in consideration of an area I alone, the multicast data is transmitted in consideration of the extended area II as shown in FIG. 5.

The node B is able to receive the multicast data from the node A in the reserved time slot 1 of the node D without collision as well. The node B to receive the multicast data can use the time slot 0 if a neighbor's neighbor node does not use the time slot with the Tx/Rx bit ‘10’.

It has been explained that time slots reserved by other nodes are used in reference to FIGS. 4 and 5. It is to be appreciated that the transmitting node can reserve and use a free time slot first, other than reserved time slots of other nodes.

In light of the foregoing as described above, a transmitting node can reserve a time slot to transmit multicast data without collision by obtaining information relating to time slots used by neighbor nodes. The data transmission rate can be improved by using received time slots not being used by a neighbor node or reserved time slots of neighbor's neighbor nodes.

While the present invention has been particularly shown and described with reference to exemplary embodiments thereof, it will be understood by those skilled in the art that various changes in form and details may be made therein without departing from the spirit and scope of the invention as defined by the appended claims.

1. A method for recognizing a receiving node by a transmitting node which transmits multicast data, and transmitting the multicast data to the recognized receiving node in a wireless network including a plurality of nodes that transmit and receive multicast data in at least one time slot, comprising:
transmitting a multicast solicit message indicating generation of the multicast data when the multicast data is generated; and
recognizing the receiving node by receiving from the receiving node a multicast join message containing information relating to the receiving node.

2. The method according to claim 1, further comprising selecting by the transmitting node at least one free time slot to reserve a time slot in which the generated multicast data is transmitted.

3. The method according to claim 2, further comprising transmitting by the transmitting node a multicast reservation request message containing information relating to the selected free time slot to the receiving node.

4. The method according to claim 3, further comprising transmitting a reservation response message to the transmitting node when the free time slot referred to in the information contained in the reservation request message does not collide with reserved time slots of other nodes.

5. The method according to claim 3, further comprising transmitting a reservation cancel message to the transmitting node when the free time slot referred to in the information contained in the reservation request message collides with reserved time slots of neighbor nodes.

6. The method according to claim 2, wherein a node in the wireless network notifies neighbor nodes of whether the node uses a reserved time slot and multicast reservation information pertaining to a state of the node.

7. The method according to claim 6, wherein the multicast reservation information is transmitted using a beacon.

8. The method according to claim 6, wherein the state of the node is one of a multicast data transmitting node, a multicast data receiving node, a unicast data transmitting node, and a unicast data receiving node.

9. The method according to claim 8, wherein the transmitting node selects a reserved time slot as the free time slot when a neighbor's neighbor node being a multicast data receiving node does not use the reserved time slot.

10. The method according to claim 8, wherein the transmitting node selects a reserved time slot as the free time slot when a neighbor node being a multicast data transmitting node does not use the reserved time slot.
